(19) United States
(12) Patent Application Publication
(10) Pub. No.: US 2014/0098038 A1
(43) Pub. Date: Apr. 10, 2014

(54) MULTI-FUNCTION CONFIGURABLE HAPTIC DEVICE

(71) Applicant: Microsoft Corporation, Redmond, WA (US)

(72) Inventors: Timothy S. Paek, Sammammish, WA (US); Hong Tan, Beijing (CN); Asela Gunawardana, Seattle, WA (US); Mark Yeend, Redmond, WA (US)

(21) Appl. No.: 13/912,220

(22) Filed: Jun. 7, 2013

Related U.S. Application Data
(63) Continuation-in-part of application No. 13/787,832, filed on Mar. 7, 2013.
Application No. 13/787,832 is a continuation-in-part of application No. 13/745,860, filed on Jan. 20, 2013.
(60) Provisional application No. 61/712,155, filed on Oct. 10, 2012.

(51) Int. Cl. G06F 3/01

(52) U.S. Cl. CPC G06F 3/016
USPC 345/173

(57) ABSTRACT

Technologies relating to touch-sensitive displays are described herein. A computing device with a touch-sensitive display is configurable to act as multiple control devices, such as a video game controller, a remote control, and music player. Different haptic regions can be assigned for the different configurations, where the haptic regions are configured to provide haptic feedback when a user interacts with such haptic regions. Thus, similar to conventional input mechanisms with physical human-machine interfaces, haptic feedback is provided as a user employs the computing device, allowing for eyes-free interaction.

### RELATED APPLICATIONS

This application claims the benefit of U.S. Provisional Patent Application No. 61/712,155, filed on Oct. 10, 2012, and entitled “ARCED OR SLANTED SOFT INPUT PANELS.” This application is also a continuation-in-part of U.S. patent application Ser. No. 13/787,832, filed on Mar. 7, 2013, and entitled “PROVISION OF HAPTIC FEEDBACK FOR LOCALIZATION AND DATA INPUT”, which is a continuation-in-part of U.S. patent application Ser. No. 13/745,860, filed on Jan. 20, 2013, and entitled “TEXT ENTRY USING SHAPEWRITING ON A TOUCH-SENSITIVE INPUT PANEL.” The entireties of these applications are incorporated herein by reference.

### BACKGROUND

Computing devices with touch-sensitive displays have been configured to present various types of graphical user interfaces that are designed to facilitate receipt of user input (e.g., by way of a tap, swipe, or other gesture). For instance, conventional mobile telephones are configured to display tiles or icons that are representative of respective applications, such that when an icon is selected, a corresponding application is initiated. Exemplary applications include an e-mail application, a maps application, a text messaging application, a social networking application, a word processing application, etc. For instance, hundreds of thousands of applications have been designed for execution on smart phones.

Further, mobile computing devices having touch-sensitive displays thereon have been configured to present soft input panels to facilitate receipt of text, where a user can set forth a word by selecting appropriate character keys of a soft input panel. Typically, on mobile computing devices, each key on a soft input panel represents a single character. Accordingly, for a user to input text to a mobile computing device using a soft input panel, the user can select (e.g., through tapping) discrete keys that are representative of respective characters that are desirably included in such text. As many mobile computing devices have relatively small screens, such computing devices have been configured with software that performs spelling corrections and or corrects for “fat finger syndrome,” where a user mistakenly taps a key that is proximate to a desirably tapped key.

Using a mobile computing device that is displaying any of the aforementioned graphical elements (icons/tiles or keys) is difficult without visually focusing on the touch-sensitive display screen of the device. Moreover, applications developed for use on computing devices with touch-sensitive displays are designed as if the user will be visually focused on content presented by such application on the touch-sensitive display. In an example, an application configured to cause the computing device to output music to a user can include a graphical user interface that visually presents a list of artists, albums, genres, songs, etc., and the user can select a desired artist, album, or the like by tapping the display of the device where such entity (artist, album, etc.) is graphically depicted. Without visually focusing on the display, a user will have great difficulty in traversing through menus or selecting a desired entity.

### SUMMARY

The following is a brief summary of subject matter that is described in greater detail herein. This summary is not intended to be limiting as to the scope of the claims.

Described herein are various technologies that facilitate eyes-free interaction with content presented via a (smooth) touch-sensitive display surface. For instance, technologies that facilitate eyes-free interaction with content presented on display surfaces of mobile computing devices, such as mobile telephones, tablet (slate) computing devices, phablet computing devices, netbooks, ultra-books, laptops, etc. are described herein.

In an exemplary embodiment, a computing device with a touch-sensitive display can comprise hardware embedded in or beneath the display that supports provision of haptic feedback to digits (fingers, thumbs, styluses, etc.) as such digits transition over specified locations of the touch-sensitive display. For example, a grid of actuators embedded in or beneath the touch-sensitive display can be employed to provide haptic feedback when a digit is detected as being in contact with certain regions on the touch-sensitive display. This hardware can be leveraged by a developer that develops an application for a computing device with a touch-sensitive display, such that when the application is executed on the computing device, the touch-sensitive display is configured to provide haptic feedback at locations specified by the developer and/or responsive to sensing one or more events specified by the developer. From the perspective of the user, the user is provided with haptic feedback that is informative as to location of digits on the touch-sensitive display as well as input being provided to the computing device by way of virtual input mechanisms represented on the touch-sensitive display.

Exemplary applications that can leverage the aforementioned hardware that supports provision of haptic feedback include applications that are configured to cause a touch-sensitive display of a computing device to be configured to represent respective conventional (physical) devices that include mechanical or electromechanical human machine interface (HMI) elements. For instance, a mobile computing device may have several applications installed thereon, wherein a first application causes the mobile computing device to be configured as a video game controller with numerous haptic regions. Such haptic regions can respectively correspond to buttons on a conventional video game controller, as well as a directional pad found on conventional video game controllers. Therefore, for example, a mobile telephone of the user can be effectively transformed into a video game controller, where the user is provided with haptic feedback as the user plays a video game (e.g., the user can view the video game being played, rather than looking at the touch-sensitive display screen of computing device configured to act as the video game controller).

Similarly, a second application installed on the computing device can cause the computing device to act as a remote control for a television, set top box, media player (e.g., CD, DVD, Blu-ray, . . . ), or the like. Accordingly, when the application is executed, the touch-sensitive display of the computing device can be configured to have multiple haptic regions corresponding to multiple input elements that are associated with conventional remote controls (e.g., a power button, “channel up”, and “channel down” buttons, “volume up” and “volume down” buttons, . . . ). Therefore, using a mobile computing device, for instance, the user can interact with the television without being forced to look at the display screen of the mobile computing device, as the user is able to feel the location of the buttons corresponding to the remote control on the touch-sensitive display surface.

In another exemplary embodiment, a computing device with a touch-sensitive display surface can be configured to allow for the employment of a virtual joystick (e.g., joystick that acts as a track pad). For example, a capacitive or resistive sensing grid can be embedded in or lie beneath the touch-sensitive display, and can output data that is indicative of locations on the touch-sensitive display where flesh of a digit is contacting the touch-sensitive display. If the digit remains stationary from some threshold amount of time while maintaining contact with the touch-sensitive display (as determined through analysis of the data output by the sensor), a determination can be made that the user wishes to initiate the virtual joystick. Subsequently, the user can lean the digit in any direction, causing a graphical object (e.g., a cursor) on the touch-sensitive display screen to move in accordance with the direction and amount of the lean of the digit. In another embodiment, leaning the digit can cause a graphical object on a display screen of a computing device in communication with the computing device having the touch-sensitive display to move in accordance with the direction and lean of the digit.

In still yet another exemplary embodiment, a computing device with a touch-sensitive display surface can support shape writing for entry of text. For example, a soft input panel (e.g., soft keyboard) can be presented on the touch-sensitive display, and user-strokes over the soft input panel can be analyzed to identify text that is desirably set forth by the user (rather than text entry through discrete taps). To facilitate development of muscle memory of the user, auditory feedback can be provided that is indicative of various aspects of strokes employed by the user when setting forth text by way of shape writing. Such auditory feedback can act as a signature with respect to a particular word or sequence of characters. For instance, auditory feedback can indicate to the user that a word has been entered correctly, without requiring the user to visually focus on the touch-sensitive display. In an exemplary embodiment, auditory effects (e.g., magnitude, pitch, type of sound) can be a function of various aspects of strokes detected when a digit transitions over the soft input panel. These aspects can include, but are not limited to, velocity, acceleration, rotational angle of a current touch point with respect to an anchor point (e.g. the beginning of a stroke, sharp turns, etc.), angular velocity, angular acceleration, etc.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 illustrates an exemplary computing device that is configured with a sensor/actuator grid that supports provision of haptic feedback to a user.

FIG. 2 illustrates an exemplary system in which a first computing device is configured to control operation of a second computing device.

FIGS. 3-6 illustrate exemplary configurations that include various haptic regions for a computing device with a (smooth) touch-sensitive display.

FIG. 7 illustrates an exemplary touch-sensitive display.

FIG. 8 illustrates an exemplary computing device that supports utilization of a virtual joystick.

FIG. 9 illustrates an exemplary system where operation of a virtual joystick on a first computing device controls display of a graphical object on a second computing device.

FIG. 10 is an exemplary system that supports shape writing.

FIG. 11 is a flow diagram that illustrates an exemplary methodology for providing haptic feedback to a digit in contact with a touch-sensitive display surface.

FIG. 12 is a flow diagram that illustrates an exemplary methodology for controlling operation of a computing device through interaction with a touch-sensitive display of another computing device.

FIG. 13 illustrates an exemplary methodology for using a virtual joystick to control graphics being presented on a display screen.

FIG. 14 is an exemplary computing system.

### DETAILED DESCRIPTION

Various technologies pertaining to touch-sensitive displays of computing devices are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary” is intended to mean serving as an illustration or example of something, and is not intended to indicate a preference.

Various technologies that facilitate eyes-free interaction with a (smooth) touch-sensitive display are set forth herein. These technologies include numerous embodiments, wherein aspects of some embodiments may be combined with aspects of other embodiments. For instance, embodiments described herein relate to provision of haptic feedback to assist a user in connection with allowing for eyes-free interaction with the touch-sensitive display. Other embodiments described herein pertain to a virtual joystick, where a user can control movement of a graphical object, such as a cursor, by establishing an initial position and subsequently leaning a digit, wherein the graphical object moves in accordance with the direction and amount of lean of the digit. Still other embodiments described herein pertain to provision of auditory feedback as a user sets forth strokes over keys of a soft input panel.

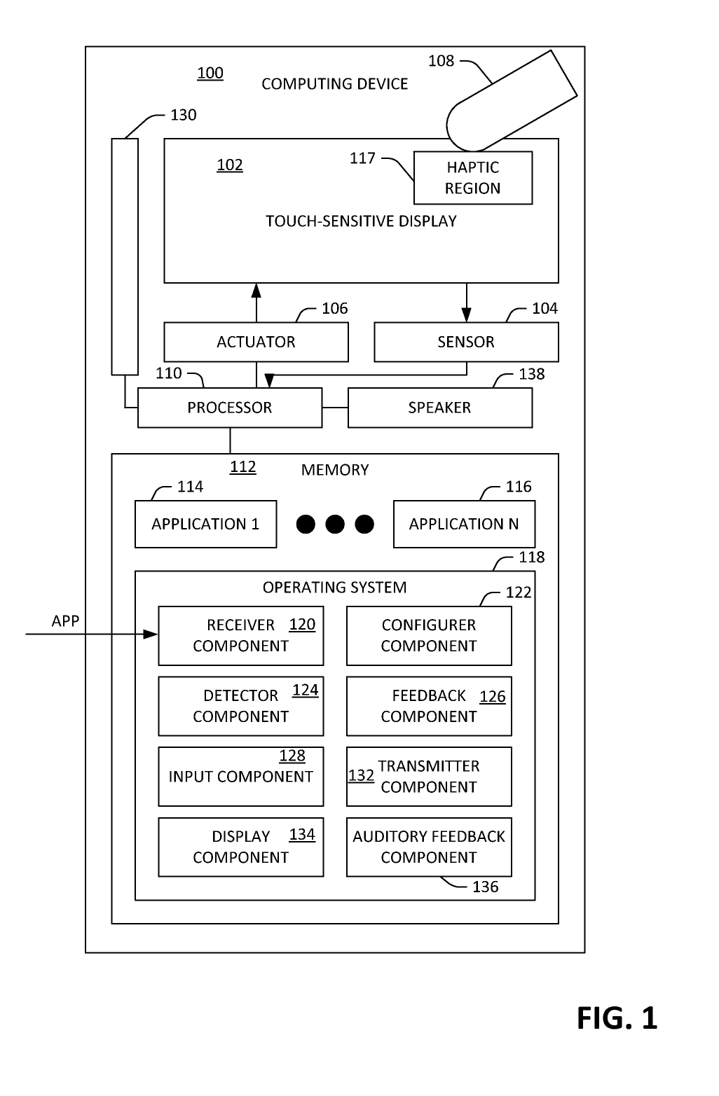

With reference now to FIG. 1, an exemplary computing device 100 is illustrated, wherein the computing device 100 includes a (smooth) touch-sensitive display 102. Accordingly, the computing device 100 may be a mobile computing device, such as a mobile telephone, a tablet (slate) computing device, a netbook, an ultrabook, a laptop, a wearable computing device (such as a watch, locket, or bracelet configured with computer hardware), or some other mobile computing device that includes a touch-sensitive display. In another exemplary embodiment, the computing device 100 may be included in an automobile as a portion of an infotainment center. That is, the touch-sensitive display 102 can be configured to receive input from a user as to climate in the automobile, a radio station being played in the automobile, amongst other data. In yet another embodiment, the computing device 100 may be an automated teller machine (ATM) or kiosk, such as a point of sale device. In still yet another embodiment, the computing device 100 may be used in an industrial setting in connection with controlling operation of a piece of industrial equipment.

The computing device 100 includes a sensor/actuator grid that is embedded in or underlies the touch-sensitive display 102. Such sensor/actuator grid is represented in FIG. 1 by a sensor 104 and an actuator 106. The sensor 104 is configured to output data that is indicative of a location on the touch-sensitive display 102 where a digit 108 is in contact or hovering immediately above the touch-sensitive display 102. Accordingly, the sensor 104 may be a capacitive sensor, a resistive sensor, a photo sensor, etc. The actuator 106 is configured to provide haptic feedback to the digit 108 when the digit 108 is in contact with the touch-sensitive display 102 at particular locations. Such haptic feedback may be vibrations, key clicks, electrostatic friction, etc.

The computing device 100 additionally comprises a processor 110 that transmits control signals to the actuator 106 based upon sensor signals received from the sensor 104. The computing device 100 further includes a memory 112 that retains a plurality of applications 114-116 that can be executed by the processor 110. The plurality of applications 114-116 correspond to respective different configurations of the computing device 100. Thus, the application 114, when executed by the processor 110, causes the computing device 100 to have a first configuration, while the application 116, when executed by the processor 110, causes the computing device 100 to have an Nth configuration. Each configuration can include causing the touch-sensitive display to have at least one haptic region, where, for instance, the haptic region can be representative of a mechanical or electromechanical input mechanism (or aspects thereof) corresponding to a respective configuration. Exemplary input mechanisms can include a button, a rotating dial or knob, a click wheel that rotates about an axis, a keypad, a key, a mechanical slider that slides along a track, a directional pad, a switch, etc. It is to be understood that a single application can define multiple haptic regions at different respective locations on the touch-sensitive display 102 that are configured to provide haptic feedback responsive to respective pre-defined events being sensed. Further, different applications may have respective haptic regions at different locations, such that locations of haptic regions for the first application 114 on the touch-sensitive display 102 are different from locations of haptic regions for the Nth application 116 on the touch-sensitive display 102. Further, different haptic regions can be representative of different respective input mechanisms, may be of different respective sizes, may be of different respective shapes, etc., so long as such shapes/input mechanisms are supported by the sensor/actuator grid underlying the touch-sensitive display 102.

In an example set forth in FIG. 1, the processor 110 can execute the first application 114, which can define a haptic region 117 on the touch-sensitive display 102. For instance, the first application 114 when executed by the processor 110, can cause the computing device 100 to be configured as a portable media player (such as a portable music player) that includes a click wheel, and optionally, at least one button. In such example, the haptic region 117 can be representative of the click wheel. Hence, when the sensor 104 outputs data that indicates that the digit 106 is in contact with the touch-sensitive display 102 at the haptic region 117 (e.g., the digit 108 is being rotated as if interacting with a click-wheel), the actuator 106 can be caused to provide haptic feedback to the digit 108 such that the user can feel clicks as the digit 108 is rotated over the haptic region 117. In another example, an application in the memory 112, when executed by the processor 110, can cause the computing device 100 to be configured as a video game controller. Thus, the touch-sensitive display 102 can be configured with several haptic regions, including haptic regions corresponding to buttons of a video game controller and haptic regions corresponding to directional buttons of a directional pad of the video game controller. Therefore, the user of the computing device 100 can employ such computing device 100 as the video game controller and can feel the location of the input mechanisms (buttons and directional pad) on the touch-sensitive display 102, allowing the user to play a video game without having to visually focus on the touch-sensitive display 102 of the computing device 100. Other exemplary configurations will be set forth below.

The memory 112 can further comprise an operating system 118 that manages hardware resources, such that the operating system 118 can be configured to cause power to be provided to the touch-sensitive display 102, the sensor 104, and the actuator 106, and to monitor output of the sensor 104. The operating system 118 is shown as including a plurality of components. It is to be understood, however, that in other embodiments, such components may be external to the operating system 118. For example, the components may be firmware in the computing device 100. In the exemplary computing device 100 shown in FIG. 1, the operating system 118 includes a receiver component 120 that receives an indication that an arbitrary application in the plurality of applications 114-116 is to be executed by the processor 110. For instance, such indication can be received from a user that is manually selecting an application from the plurality of applications 114-116 (e.g. from selecting a graphical icon that is representative of the application). In another example, the receiver component 120 can receive the indication based upon a detection that the computing device 100 is in geographic proximity to some other device that can be controlled or receive input from the computing device 100 when configured in accordance with the application (e.g., via near-field communication signals (NFC), Bluetooth, . . . ). For instance, if the memory 112 includes an application that causes the computing device 100 to be configured as a video game controller, the receiver component 120 can receive the indication upon the computing device 100 being detected as being within some threshold distance from a video game console.

In still other examples, an application from the plurality of applications 114-116 can be invoked as a function of various possible parameters. For instance, a user can invoke the particular application by holding the computing device 100 in a certain manner (e.g., a certain position of digits on the touch-sensitive display 104). In another example, a user can invoke the particular application by orienting the computing device 100 in a particular orientation. In still yet another example, a user can invoke the particular application by orienting the computing device 100 in particular orientation relative to another device in communication with the computing device 100 (e.g., pointing the computing device 100 at another computing device in some posture). In still other examples, a user can invoke the particular application by producing an invocation gesture that is detected by sensors of the device (e.g., the touch-sensitive display 104, an accelerometer, a gyroscope, a photosensor, a combination thereof, . . . ) or by manipulating hardware of the computing device (e.g., depressing buttons, unfolding or bending the computing device 100, etc.).

The operating system 118 further comprises a configurer component 122 that configures the computing device 100 in accordance with the arbitrary application executed by the processor 110. For purposes of explanation, the arbitrary application may be the first application 114. Thus, as noted above, the first application, when executed by the processor 110, defines the haptic region 117 (and possibly other haptic regions) that is representative of an input mechanism. The configurer component 122 can configure the touch-sensitive display 102 such that the touch-sensitive display 102 includes the haptic region 117. That is, the configurer component 122 can be employed to control the actuator 106, such that haptic feedback is provided when the digit 108 is in contact with the touch-sensitive display 102 at the haptic region 117 (optionally after an event or sequence of events has been detected). Hence, a developer of an application can define locations on the touch-sensitive display 102 that are desirably haptic regions corresponding to input mechanisms, and the configurer component 122 can configure the hardware of the computing device 100 to provide haptic feedback to the digit 108 at the locations on the touch-sensitive display 102 defined as being haptic regions by the application.

The operating system 118 can further comprise a detector component 124 that can receive data output by the sensor 104, and can detect an input gesture over the haptic region 117. Thus, for instance, if the haptic region 117 is defined by the first application 114, and the first application 114 is being executed by the processor 110, the detector component 124 can receive data output by the sensor 104 and can detect when the digit 108 is in contact with the touch-sensitive display 102 at the haptic region 117 based upon the data output by the sensor 104. A feedback component 126, responsive to the detector component 124 detecting that the digit 108 is in contact with the touch-sensitive display 102 at the haptic region 117, can cause haptic feedback to be provided to the digit 108. Thus, the feedback component 126 is operable to cause the actuator 106 to provide haptic feedback to the digit 108.

In an exemplary embodiment, the detector component 124 and the feedback component 126 can act in conjunction to differentiate between gestures performed by the digit 108 for localization and data input. For instance, if a user is not visually focusing on the touch-sensitive display 102, the user may transition the digit 108 over the surface of the touch-sensitive display 102 to localize the digit 108 (e.g., locate a particular haptic region that may desirably be interacted with subsequent to being located). In an example referencing a conventional keyboard, this is analogous to the user initially orienting her fingers on the keyboard by feeling the position of her fingers over the keys prior to depressing keys. The detector component 124 and the feedback component 126 can differentiate between localization and data input by way of a predefined toggle command. Pursuant to an example, prior to receipt of a toggle command, as the digit 108 transitions over the touch-sensitive display 102, it can be inferred that the user is attempting to localize the digit 108 over a particular haptic region that is representative of an input mechanism. Once the user locates such haptic region, the user may set forth a toggle command, which can be identified by the detector component 124, wherein the toggle command indicates a desire of the user to provide input (e.g., interact with the haptic region to set forth input to the application). Such toggle command may be a spoken utterance, applying additional pressure to the touch-sensitive display 102, a quick shake of the mobile computing device 100, a tap, a double-tap, etc.

The operating system 118 may further include an input component 128 that generates input data responsive to the detector component 124 detecting an input gesture over the haptic region 117 (and responsive to detecting that the user wishes to provide input to the application being executed by the processor 110 rather than localizing the digit 108 on the touch-sensitive display 102). For example, if the application executed by the processor 110 causes the computing device 100 to be configured as a remote control for controlling a television, and the detector component 124 detects that the digit 108 is setting forth an input gesture with respect to the haptic region 117 (which, for example, may represent a “channel up” button), the feedback component 126 can be configured to provide haptic feedback to the digit 108 when performing the input gesture (analogous to the digit 108 being provided with haptic feedback when pressing a button on a conventional remote control), and the input component 128 can generate input data and provide such data to the application 114. The input data provided to the application by the input component 128 can inform the application that the digit 108 has been used to select a virtual button, for example.

In various embodiments described herein, the computing device 100, when executing one or more of the applications 114-116, can be configured as an input/control device for controlling or sending control signals to at least one other device (which may be a computing device, a mechanical device, an electromechanical device, etc.). Therefore, the computing device 100 can include an antenna 130 that can be configured to transmit control signals from the computing device 100 to some other device. As indicated above, the computing device 100 can be configured as a television remote control, a video game controller, an infotainment center, etc. Additionally, the computing device 100 can be configured as a control mechanism for controlling a robotic device, an industrial machine, etc., wherein the antenna 130 is employable to transmit control commands from the computing device 100 to one of such other devices.

To that end, the operating system 118 may additionally include a transmitter component 132 that receives output data generated by the application executed by the processor 110 (e.g., responsive to the input component 128 providing the application with the input data), and causes such output data to be transmitted to another device by way of the antenna 130. Again, such output data may be configured to control operation of another device that is in communication with the computing device 100. Furthermore, while the computing device 100 is shown as including an antenna 130, it is to be understood that a wired connection between the computing device 100 and the another computing device is also contemplated. Pursuant to an example, when executing the first application 114, the computing device 100 can be configured to control operation of the another computing device, where the another computing device may be a television, a set top box, a game console, etc., and operation of the another computing device that can be controlled through operation of the computing device 100 can include displaying graphical content based upon output data from the first application. For instance, when the computing device 100 is configured as a video game controller and is in communication with a video game console, data output by the computing device 100 can cause graphical data displayed to a video game player to be updated as such video game player interacts with the computing device 100. Similarly, when the computing device 100 is configured as a television remote control, user interaction with the computing device 100 can cause content displayed on a television to be updated.

In another exemplary embodiment, an application executed by the processor 110 can contemplate use of a virtual joystick. Further, the operating system 118 can be configured to support a virtual joystick. A virtual joystick may be particularly well-suited for use when display screen real-estate is limited (e.g., such as mobile phones, tablets, or wearables), where a relatively small portion of the display is used when the virtual joystick is employed. For instance, the virtual joystick can be configured to control direction/velocity of movement of at least one graphical object (e.g., a cursor) while the digit 108 is in contact with the touch-sensitive display 102 and remains relatively stationary. Such functionality will be described in greater detail below. Generally, however, the detector component 124 can receive data output by the sensor 104, and can detect that the virtual joystick is desirably initiated (e.g., the user may position the digit 108 on the touch-sensitive display 102 and provide pressure or hold such digit 108 at that location for a threshold amount of time). The detector component 124 may then detect a lean of the digit 108 on the touch-sensitive display 102 (e.g., the digit is leaned left, right, up, or down) and position and movement of a graphical object can echo the direction and amount of lean detected by the detector component 124 based upon data output by the sensor 104. To that end, the operating system 118 can include a display component 134 that updates graphical data displayed on the touch-sensitive display 102 (or another display in communication with the computing device 100) based upon the detector component 124 detecting that the digit 108 is being leaned in a certain direction. This functionality can be used for controlling location and direction of a cursor, scrolling through content, controlling location and direction of an entity in a video game, etc.

It is also contemplated that virtual joystick functionality can be utilized to control graphics displayed on a second computing device that is in communication with the computing device 100. In an exemplary embodiment, the processor 110 can execute an application that causes the computing device 100 to be configured as a video game controller, wherein such video game controller includes a joystick. To represent such joystick, the digit 108 can be placed in contact with the touch-sensitive display 102 at location of the joystick on the touch-sensitive display 102, and can lean the digit 108 as if the digit 108 were employed to lean a joystick. This can cause output data to be transmitted by way of the antenna 130 to a video game console, which updates game data as a function of the detected direction and amount of lean of the digit 108 on the touch-sensitive display 102. In yet another exemplary embodiment, the computing device 100 may be a wearable, such as a watch, and the application executed by the computing device 100 can be a television remote control. As the watch may have a relatively small amount of real estate for the touch-sensitive display 102, the application can be configured to allow for the virtual joystick to be utilized to change volume of a television, to change a channel being viewed by a user, to control a cursor, to select a channel, etc.

The operating system 118 may also include an auditory feedback component 136 that can control a speaker 138 in the computing device 100 to provide auditory feedback to a user of the computing device 100 as the user interacts with the touch-sensitive display 102. The auditory feedback provided by the auditory feedback component 136 can assist a user in developing muscle memory, allowing for the user to repeat and/or recognize successful completion of certain gestures over the touch-sensitive display 102 without being forced to visually focus on the touch-sensitive display 102. In an exemplary embodiment, the haptic region 117 can represent a depressible button, such that when the digit 108 performs a gesture over the haptic region 117 indicating a desire of the user to press such button, the digit 108 receives haptic feedback as well as auditory feedback (e.g. the sound of the pressing of a button). Likewise, if the haptic region 117 represents a switch, the feedback component 136 can be configured to cause haptic feedback to be provided to the digit 108 as the digit 108 performs an input gesture over the haptic region 117, and the auditory feedback component 136 can be configured to cause auditory feedback such that the speaker 138 outputs an auditory signal (e.g., the sound of a switch being flipped).

In another exemplary embodiment, an application executed by the processor 110 can be configured to receive input by way of shape writing over a soft input panel (SIP). Thus, the digit 108 transitions between/over keys in the SIP, and words are constructed as a function of continuous/contiguous strokes over keys of the SIP. The auditory feedback component 136 can cause the speaker 138 to output audible data that can be a signature for a sequence of strokes over the SIP. Thus, over time, as a user repeats certain gestures to form particular word using the SIP, the auditory feedback component 136 can cause the speaker 138 to output audible signals that act as a signature for such sequence of strokes. Audible effects that can be caused to be output by the speaker 138 by the auditory feedback component 136 include certain types of sounds (e.g., sound of an engine, a swinging sword, wind, . . . ), pitch, magnitude, and the like. Such effects can be designed to be indicative of various properties of a stroke or sequence of strokes, such as velocity of a stroke, acceleration of a stroke, deceleration of a stroke, rotation angle between strokes, rotational acceleration or deceleration, etc.

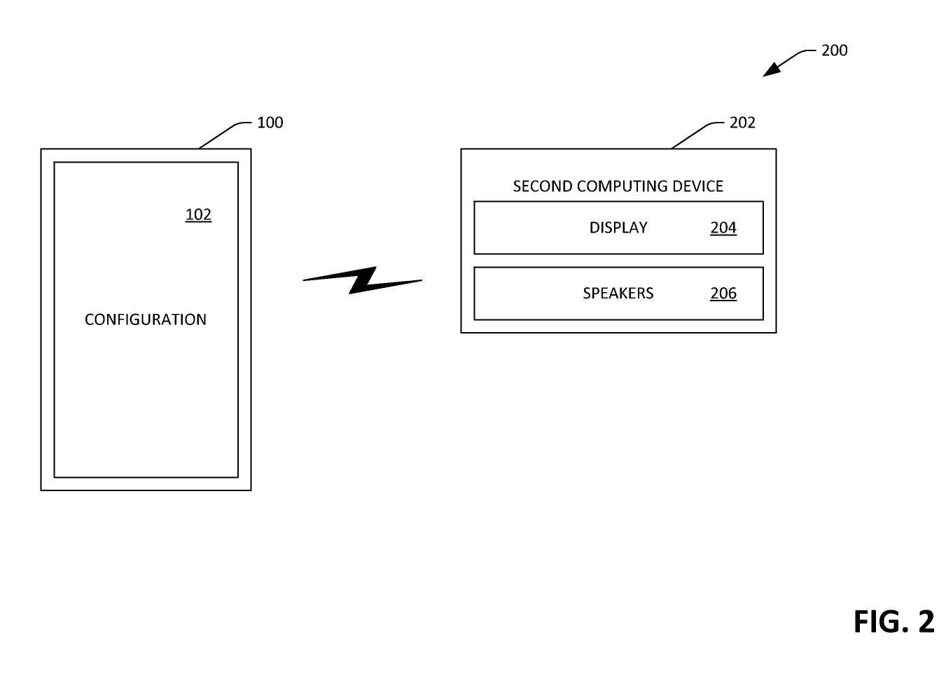

With reference now to FIG. 2, an exemplary system 200 where the computing device 100 is employed to provide control data to a second computing device 202 is illustrated. The processor 110 of the computing device 100 executes an application that causes the computing device 100 to have a particular configuration, wherein such configuration includes at least one haptic region on the touch-sensitive display 102 that corresponds to an input mechanism (e.g., a slider, a button, a switch, a directional pad, . . . ). In an exemplary embodiment, the second computing device 202 includes a display 204 and speakers 206. While the display 204 and speakers 206 are shown as being internal to the second computing device 202, it is to be understood that the display 204 and speakers 206 may be external to the second computing device 202 (and in communication with the second computing device 202). For instance, if the second computing device 202 is a set top box, the display 204 and speakers 206 can be included in a television that is in communication with such set top box.

A user can interact with the computing device 100 by, for example, providing input gestures over the touch-sensitive display 102 through use of a digit (finger or thumb). As the digit is placed at certain locations on the touch-sensitive display 102 (locations corresponding to haptic regions for the configuration of the application being executed on the computing device 100), haptic feedback is provided to the digit, such that the user is provided with analogous sensation of interacting with a conventional input mechanism while using the computing device 100. Additionally, the computing device 100 can provide auditory and/or visual feedback.

As the user interacts with the touch-sensitive display 102, the user is controlling operation of the second computing device 202. For example, content being displayed on the display 204 can be based upon user interaction with the touch-sensitive display 102 of the computing device 100. Likewise, output of the speakers 206 can be based upon user interaction with the touch-sensitive display 102 of the computing device 100.

In an exemplary embodiment, a plurality of applications can be installed on the computing device 100 that can allow for conventional devices used to control content displayed on a television or output by an entertainment system to be replaced with the computing device 100. For instance, a first application installed on the computing device 100 can cause the computing device 100 to be configured as a remote-control for a television; a second application installed on the computing device 100 may cause the computing device 100 to be configured as a video game controller for controlling or playing a video game; a third application installed on the computing device 100 can cause the computing device 100 to be configured as a remote control for a DVD player, Blu-ray player, or other media player; a fourth application installed on the computing device 100 can cause the computing device 100 to be configured as a remote control for a set top box in communication with a television (e.g., a conventional cable or satellite set top box, a media streaming device, etc.); a fifth application installed on the computing device 100 can cause the computing device 100 to be configured as an AM/FM tuner; a sixth application installed on the computing device 100 can cause the computing device 100 to be configured as a remote control for an audio receiver, etc.

Hence, it can be ascertained that the computing device 100 can be configured as a universal control device for media that can be consumed by a user, in addition to operating as a mobile telephone, a tablet computing device, etc. In an exemplary embodiment, each application that causes the computing device 100 to be configured as a respective input/control device can be developed by a different respective application developer. Thus, for example, if the computing device 100 includes a first application that causes the computing device 100 to be configured as a video game controller for a video game console manufactured by a first manufacturer, and also includes a second application that causes the computing device 100 to be configured as a remote control for a television manufactured by a second manufacturer, such applications can be developed by the two different manufacturers, allowing the manufacturers to develop interfaces that differentiate/identify their respective products.

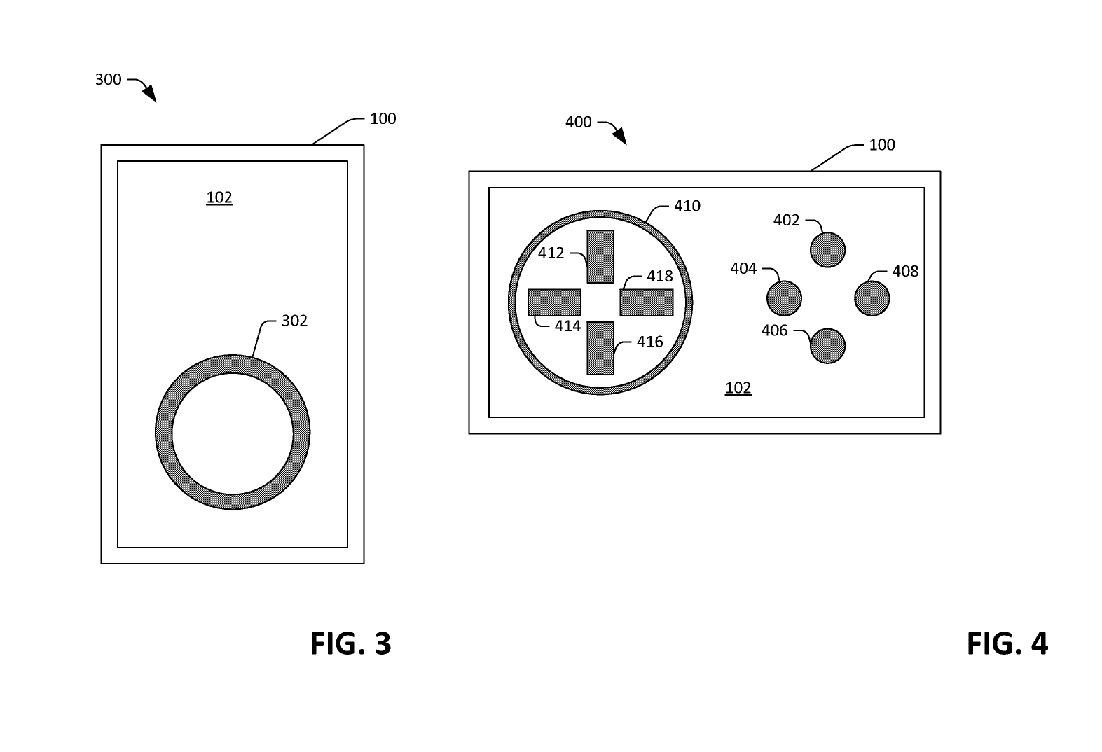

With reference collectively to FIGS. 3-6, exemplary configurations corresponding to the exemplary applications 114-116 installed on the computing device 100 are set forth. It is to be understood that the configurations are set forth are exemplary in nature, and are provided for purposes of explanation, and are not intended to limit the hereto-appended claims.

Turning solely to FIG. 3, an exemplary configuration 300 of the mobile computing device 100 as a mobile music player is illustrated. In the example shown in FIG. 3, the computing device 100 includes an application installed thereon that, when executed, causes the computing device 100 to be configured as a mobile music player. The application defines a haptic region 302 on the touch-sensitive display 102, wherein the haptic region 302 is representative of a click wheel, where the user is to rotate a digit about a track. As the digit 108 of the user transitions over the haptic region 302 (e.g., around the track), the digit 108 can be provided with haptic feedback that allows the user to interact with the computing device 100 without having to focus on the touch-sensitive display 102. Thus, as the digit 108 transitions over boundaries of the haptic region 302, haptic feedback can be provided to assist the user in localizing the digit 108 on the touch-sensitive display 102.

When the user wishes to provide input to the computing device, the haptic region 302 can be configured to provide appropriate haptic feedback. Thus, as the digit 108 rotates around the track (e.g., the haptic region 302), as when interacting with a click wheel, the haptic region 302 can be configured to provide haptic feedback that is analogous to clicks felt by a user when rotating the digit 108 about such track. For instance, certain regions of the track can be configured to cause the user to perceive greater friction at certain portions of the haptic region 302 (e.g., by way of electrostatic feedback), such that the user haptically perceives clicks as the digit 108 rotates about the track. Auditory feedback can also be provided to assist the user in interacting with the haptic region 302 without being forced to look at the touch-sensitive display 102. From the perspective of the developer, the developer need only define the location of the haptic region 302, type of haptic feedback that is to be provided to the digit 108 as the digit interacts with the haptic region 302, and events that cause such haptic feedback to be provided. The receiver component 120, the configurer component 122, the detector component 124, and the feedback component 136 can operate in conjunction to cause the desired haptic feedback to be provided to the digit 108 as the user interacts with the touch-sensitive display 102.

Turning now to FIG. 4, another exemplary configuration 400 of the computing device 100 is illustrated. In the configuration 400, the computing device 100 acts as a video game controller for controlling at least one aspect of a video game being played by a user of the computing device 100. A plurality of haptic regions 402-408 can be defined on the touch-sensitive display 102 at a respective plurality of locations, wherein such haptic regions 402-408 are representative of respective buttons on a conventional video game controller. The configuration 400 further can include a haptic region 410 that can assist a user in locating boundaries of a directional pad. The configuration 400 further includes a plurality of buttons 412-418 that are representative of respective buttons of a directional pad. In an exemplary embodiment, as the digit 108 of the user transitions over the haptic regions 402-408, haptic feedback can be provided to the digit 108 to assist the user in localizing the digit 108 with respect to the haptic regions 402-408 (and thus, the buttons represented by the respective haptic regions 402-408). The user may then select a haptic region (button) by, for example, providing an increase in pressure to the digit 108 at the desirably selected haptic region, by tapping the haptic region, etc. Furthermore, to assist the user in differentiating between buttons, each of the haptic regions 402 through 408 may be provided with different haptic feedback. For instance, if the haptic feedback is electrostatic friction, different amounts of friction can be associated with the different haptic regions 402-408. Accordingly, without having to look at the touch-sensitive display 102, the user can recognize which haptic region, and thus which button, the digit 108 is in contact with on the touch-sensitive display 102.

Meanwhile, the user may employ another digit to interact with the haptic regions that are representative of the directional pad. For instance, a user may position her left thumb on the touch-sensitive display 102 and localize the thumb with the directional pad when receiving haptic feedback when in contact with the haptic region 410. As haptic feedback is provided for each haptic region 412-418 that is representative of respective buttons of a directional pad, the user can localize her left thumb relative to the haptic regions 412-418 and may subsequently provide input to the computing device 100 (which is then transmitted to a video game console, for example). Furthermore, it is contemplated that different types of haptic feedback can be provided to differentiate between localization and input. For instance, a first type of haptic feedback may be provided to assist in localizing digits on the touch-sensitive display 102 (e.g., electrostatic friction), while a second type of haptic feedback (e.g., vibration or key clicks) may be provided when the user is providing input at a haptic region on the touch-sensitive display 102.

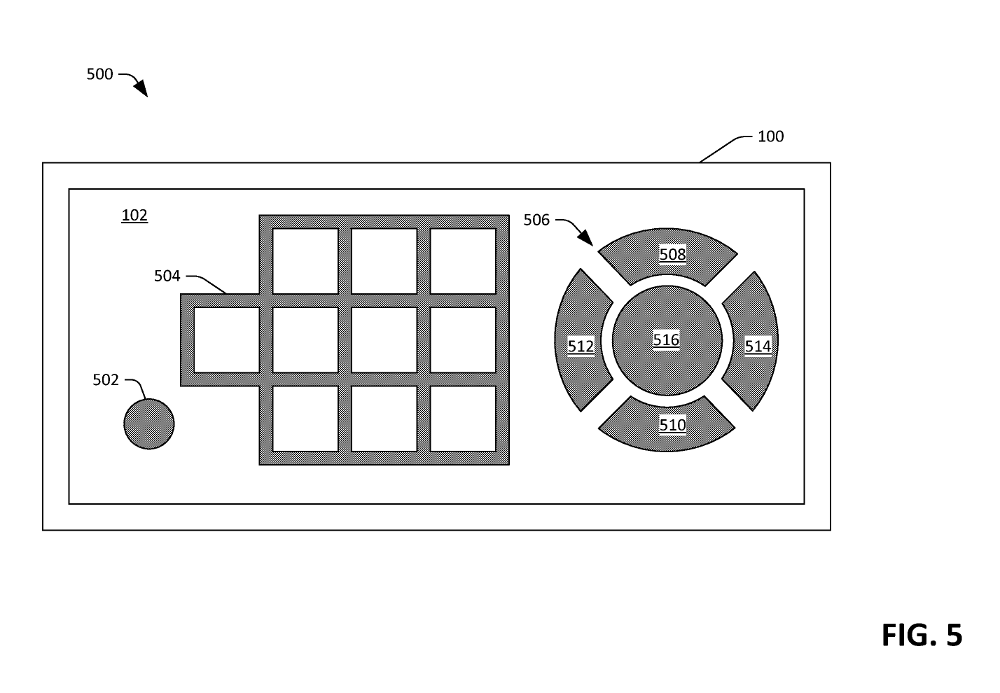

With reference now to FIG. 5, another exemplary configuration 500 of the computing device 100 is illustrated, where the computing device 100 is configured as a remote control for a television or set top box. In such configuration 500, the touch-sensitive display 102 includes a first haptic region 502 that is representative of a power button, a second haptic region 504 that is representative of 10 numerical keys, and a third haptic region 506 that is representative of a series of buttons utilized to change a channel, change a volume or select a selectable menu option. With more specificity, the haptic region 506 can include a first haptic region 508 that is representative of a “channel up” button, such that when an input gesture is detected over the first haptic region 508, the computing device 100 transmits a signal to a television, set top box, or the like that causes the channel to be changed upwardly. Similarly, a second haptic region 510 region represents a “channel down” button, a third haptic region 512 represents a “volume down” button, and a fourth haptic region 514 represents a “volume up” button. A fifth haptic region 516 represents a selection button that, when pressed by a user, can select a (highlighted) selectable option.

In operation, the user can initiate an application associated with such configuration 500 and then may transition the digit 108 over the touch-sensitive display 102 to locate the haptic region 502 that is representative of a power button of a conventional remote control. The user may then select the haptic region 502 by applying increased pressure at the haptic region 502, by tapping the haptic region 502, etc. The user may then wish to change the channel to a particular channel through utilization of a virtual keyboard represented by the haptic region 504. The haptic region 504 is shown as including numerous boundaries for keys, although in other embodiments the keys themselves may be haptic regions, some keys may be configured as haptic regions (e.g., in a checkerboard pattern), etc. In the configuration 500 shown in FIG. 5, as the digit 108 transitions over the haptic region 504, the user can be provided with haptic feedback that is indicative of the location of such boundaries, and therefore, is indicative of location of particular keys in the virtual keyboard. For instance, the user may select particular keys subsequent to localizing the digit 108 in the virtual keyboard, and then may desire to depress the button represented by the haptic region 516. To that end, the digit 108 can be transitioned to the haptic region 506, where the user can recognize the shape of the haptic region 506 based upon provided haptic feedback as the digit 108 transitions over portions of the haptic region 506. The user may then, for instance, tap at a location corresponding to the haptic region 516 causing the channel to be changed to the channel indicated by the user when interacting with the haptic region 504. The user may then wish to decrease the volume, and thus can slide the digit 108 leftwardly to the haptic region 512 and tapping such haptic region 512. Again, this is analogous to how users conventionally interact with remote controls, allowing the user to view the television while employing the computing device 100 with the smooth touch-sensitive display 102.

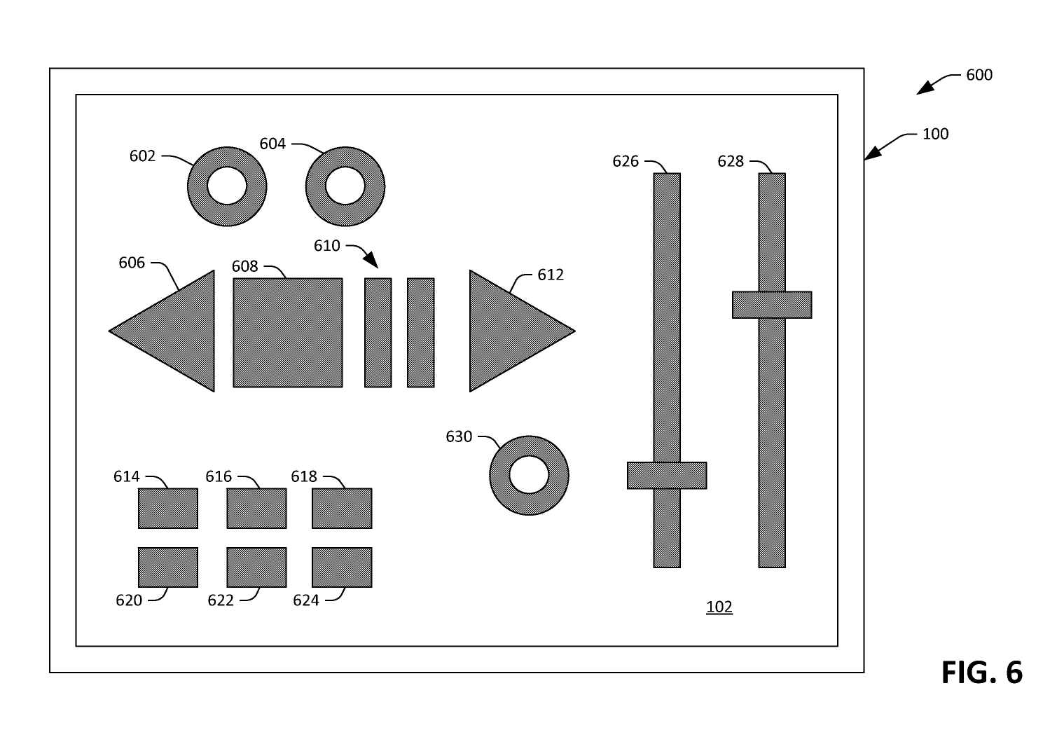

Referring now to FIG. 6, yet another exemplary configuration 600 is shown. In the exemplary configuration 600, the computing device 100 is employable as a control panel for an infotainment system in an automobile. The exemplary configuration 600 includes a plurality of haptic regions 602-612 for controlling media being output by a speaker system or video system of an automobile. For instance, a first haptic region 602 can be representative of a first rotating dial that, when rotated, controls volume output by speakers of an audio system of the automobile. A second haptic region 604 can be representative of a second rotating dial that, when rotated, can be used to control an AM/FM/satellite radio tuner. A third haptic region 606, a fourth haptic region 608, a fifth haptic region 610, and sixth haptic region 612 can represent selectable buttons that can be used to control media being played by way of an audio and/or video system of the automobile. For instance, the fifth haptic region 610 can be representative of a pause button, such that when an input gesture is set forth by the user over the fifth haptic region 610, media being output by an audio and/or video system of the automobile is paused.

The configuration may further comprise a second plurality of haptic regions 614 -624 that are representative of buttons for preset radio stations. Thus, the digit 108 can provide an input gesture on the touch-sensitive display at the haptic region 618, which causes a radio station programmed as corresponding to such haptic region 618 to be selected and output by way of speakers of the automobile.

The configuration may further include a third plurality of haptic regions 626-628 that can be representative of mechanical sliders that can control respectively, temperature of an automobile and fan speed of a heating/cooling system of the automobile. When the digit 108 interacts with the haptic regions 626 and 628, haptic feedback can be provided that assists the user in moving a slider along a predefined track (e.g., additional friction may be provided to the digit 108 of the user as the digit 108 transitions onto such track). Finally, a haptic region 630 may represent a rotating dial that can be employed to control a type of climate control desired by the user (e.g., defrost, air-conditioning, etc.). In this exemplary embodiment, the computing device 100 can be installed directly in the automobile. In another example, the computing device 100 may be a mobile computing device that can be used by the user to control aspects of operation of the infotainment center without being forced to take her eyes off the road.

Various exemplary configurations have been provided herein having haptic regions that are representative of various types of mechanical/electro-mechanical input mechanisms. It is to be understood that haptic regions can be configured to be representative of other types of input mechanisms, and any suitable haptic region that uses localized or global (e.g., an entire device vibrates) haptic feedback to represent an input mechanism is contemplated. Exemplary input mechanisms and manners to represent such input mechanisms by way of localized haptic feedback include: a virtual button, where haptic feedback is provided as the digit 108 passes through boundaries of the virtual button; a virtual track pad, where haptic feedback is provided as the digit passes through boundaries of the virtual track pad; arrays of buttons, where different haptic feedback is provided for respective different buttons in the array; a directional pad/virtual joystick for the digit 108, where haptic feedback is provided as a function of direction of a detected lean and/or amount of a detected lean; a mechanical slider, where haptic feedback is provided to indicate that the slider is restricted to sliding along a particular track; a circular slider (a click wheel), where haptic feedback (e.g., clicks) is provided as the digit 108 passes over certain portions of a track of the click wheel; a circular slider or rotating dial, where haptic feedback is provided as the digit 108 rotates in certain directions, etc. Exemplary input mechanisms and manners to represent such input mechanisms by way of global haptic feedback include vibrations that shakes up the whole controller as confirmation of an input by a digit on a touchscreen.

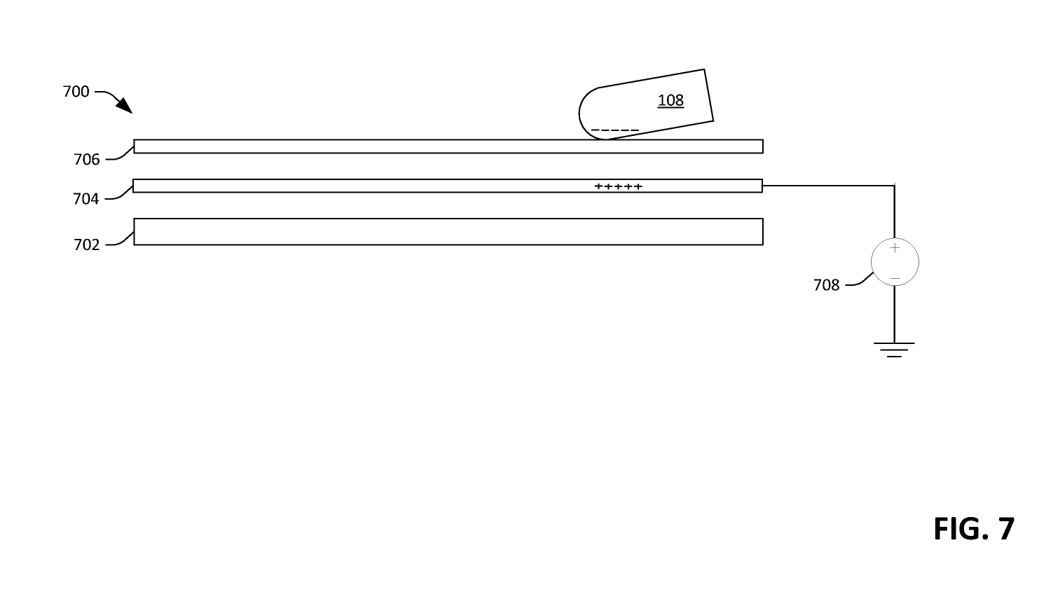

Referring now to FIG. 7, an exemplary touch-sensitive display 700 that can provide localized haptic feedback is illustrated. The exemplary touch-sensitive display 700 provides a mechanism that can be employed in connection with modulating surface friction of a smooth surface, such as glass. The touch-sensitive display 700 comprises a glass layer 702, and transparent conducting layer 704 that is placed adjacent to the glass layer 702, wherein, for example, the transparent conducting layer 704 may be composed of indium tin oxide or other suitable transparent conducting layer. The touch-sensitive display 700 may also comprise an insulating layer 706 positioned adjacent to the transparent conducting layer 704, such that the transparent conducting layer 704 is between the glass layer 702 and the insulating layer 706.

A voltage source 708 is configured to provide an appropriate amount of voltage to the conducting layer 704. When the digit 108 is in contact with the insulating layer 706, and electric current is provided to the conducting layer 704 via the voltage source 708, such electric current induces charges in the digit 108 opposite to the charges induced in the conducting layer 704. As shown in FIG. 7, inducement of a positive charge in the conducting layer 704 is caused when electric current is provided to the conducting layer 704. When the digit 108 is placed in contact with the insulator layer 706, a negative charge inside the skin of the digit 108 is induced.

The friction force f is proportional to μ (the friction coefficient of the glass surface) and the sum of F_{f} (normal force the digit 108 exerts on the surface when pressing down) and Fₑ (electric force due to the capacitive effect between the digit 108 and the conducting layer 704) as follows:

f=μ(F_{f}+Fₑ) (1)

As the strength of the current received at the conducting layer 704 changes, changes in f result. The user can sense the change in f, but not the change in Fₑ (as the force is below the human perception threshold). Accordingly, the user subconsciously attributes changes in f to μ, causing the illusion that roughness of an otherwise smooth glass surface changes as a function of a position of the digit 108 on the touch-sensitive display 102. Thus, the user can perceive, at certain programed locations, changes in friction. While electrostatic friction has been set forth as an exemplary type of haptic feedback that can be provided to the digit 108 on the touch-sensitive display 102, it is to be understood that other mechanisms for providing haptic feedback are contemplated. For example, piezoelectric actuators can be embedded in the touch-sensitive display 102 or placed beneath the touch-sensitive display in a particular arrangement (grid), such that certain piezoelectric actuators can be provided with current to allow for localized vibration or global vibration. For instance, key clicks can be simulated using such technologies. Other types of mechanisms that can provide local or global haptic feedback are also contemplated, and are intended to fall under the scope of the hereto-appended claims.

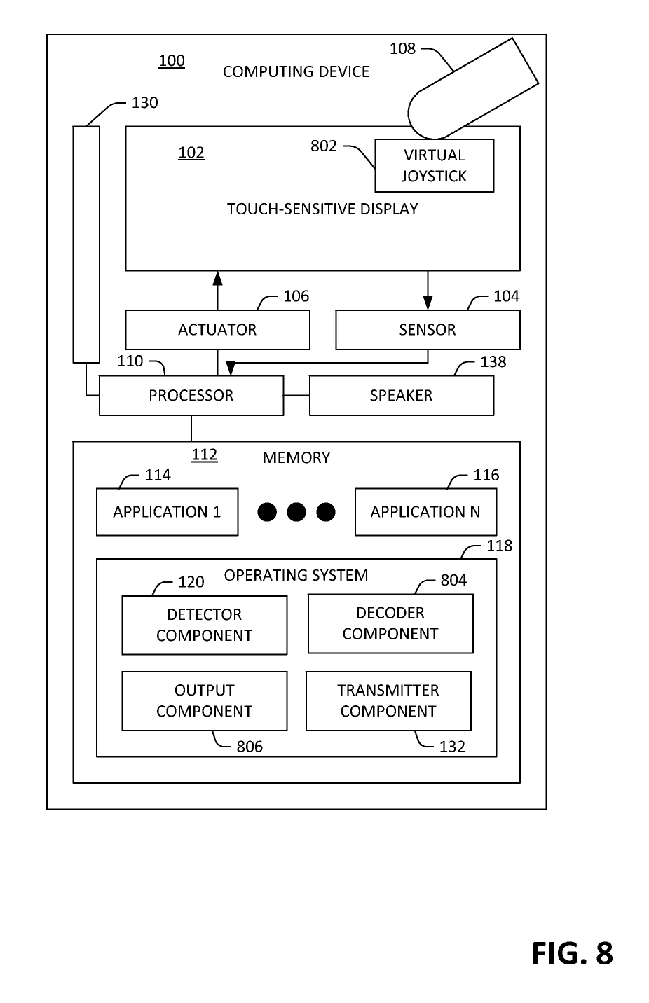

With reference now to FIG. 8, the computing device 100 when configured to support a virtual joystick 802 on the touch-sensitive display 102 is illustrated. In an exemplary embodiment, the virtual joystick 802 may be associated with a static, defined location on the touch-sensitive display 102. In another exemplary embodiment, the virtual joystick 802 can be initiated at any location on the touch-sensitive display 102 responsive to a predefined user interaction with the computing device 100 (e.g., placing and holding the digit 108 for some threshold amount of time on the touch-sensitive display).

Pursuant to an example, the digit 108 can be placed in contact with the touch-sensitive display 102 and remain stationary for some threshold amount of time (e.g., a second). The sensor 104, which can be a capacitive or resistive sensor, can output raw sensor data. Conventionally, such data output by the sensor 104 is aggregated to identify a centroid of the digit 108 when in contact with the touch-sensitive display 102. When the virtual joystick 802 is used, however, an entire region of the touch can be analyzed. The detector component 120 can receive data output by the sensor 104 and can ascertain that the virtual joystick 802 is to be initiated. Subsequently, the user can lean the digit 108 in a certain direction with a particular amount of lean, the digit 108 remains relatively stationary on the touch-sensitive display 102. The sensor 104 continues to capture data indicative of an entire region of contact of the digit 108 with the touch-sensitive display 102, and a decoder component 804 in the operating system 118 can receive such sensor data. The decoder component 804 can cause a graphical object (e.g., a cursor) shown on a display screen (e.g., the touch-sensitive display 102 or another display) to echo the amount/direction of the lean of the digit 108. That is, as the digit 108 is leaned to the left, the graphical object can be moved in accordance with the direction and amount of such lean. The decoder component 804 can decode the desired direction and velocity of movement of the graphical object as a function of the detected amount of lean of the digit 108 and direction of such lean (e.g., the greater the amount of the lean, the higher velocity of movement of the graphical object).

The operating system 118 may optionally comprise an output component 806 that generates output data based upon output of the decoder component 804. Such output data generated by the output component 806 may be used to control the graphical data on the touch-sensitive display 102 and/or on a display of a computing device in communication with the computing device 100. The transmitter component 132, in an exemplary embodiment, can control the antenna 130 to transmit a control signal to the other computing device, causing the graphical object to have a location and movement in accordance with the detected direction/amount of lean of the digit 108.

An exemplary, non-limiting embodiment is described herein for purposes of explanation. For instance, the computing device 100 may be a relatively small computing device, such as, a mobile telephone or a wearable (e.g., a watch). The computing device 100 may also be configured to control display data shown on a second computing device. For instance, the computing device 100 may be desirably used to position and move a cursor for selecting content displayed on a television screen. The user can place the digit 108 on the touch-sensitive display 102, and leave the digit 108 stationary for some relatively small amount of time. This can cause a cursor to be displayed on the television screen. The user may then lean the digit 108 in a direction of desired movement of the cursor, which causes the cursor shown on the television to move in the direction of the lean (e.g., the transmitter component 132 transmits control data by way of the antenna 130 to the television). The user may then tap the digit 108 on the touch-sensitive display 102 once the cursor is at the desired location on the television. While such example has described a cursor shown on a display screen other than the touch-sensitive display 102, it is to be understood that the virtual joystick 802 may be used to control location/movement of a graphical object on the touch-sensitive display 102.

In an exemplary embodiment, the decoder component 804 can take unintentional/intentional drift of the digit 108 into consideration when ascertaining a desired direction/amount of lean of the digit 108. For instance, the decoder component 804 can cause movement of graphical object to be invariant to drift of the digit 108. That is, if the touch-sensitive display 102 has a very smooth surface, the digit 108 may (unintentionally) drift over time. The decoder component 804 can account for such drift by making movement of the cursor invariant to such drift. To assist in preventing drifting of the digit 108 when the virtual joystick 802 is employed, haptic feedback can be provided to indicate to the user that the digit 108 is drifting. For instance, if the virtual joystick 802 is initiated, electrostatic friction can be provided around the identified location of the digit 108 on the touch-sensitive display 102 to assist the user in preventing drift. Furthermore, in some embodiments (e.g., when the virtual joystick 802 is used to control a portion of a video game), the computing device 100 can support two virtual joysticks simultaneously.

The decoder component can be trained based upon training data obtained during a training data collection phase. For example, training data can be collected by monitoring user interaction with touch-sensitive displays desiring to employ the virtual joystick, where users are asked to label their actions with desired outcomes. Based upon such labeled data, parameters of the decoder component 804 can be learned.

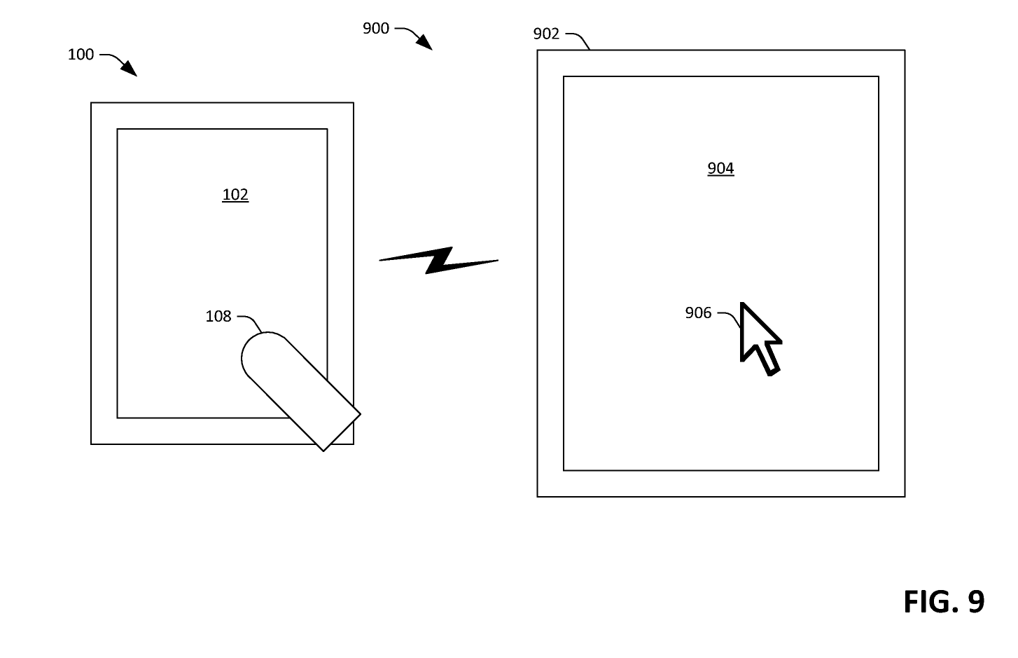

Now referring to FIG. 9, an exemplary system 900 where a virtual joystick can control position of graphical data on a display screen of a computing device is illustrated. The system 900 includes the computing device 100 and a second computing device 902, which has a display screen 904. The computing device 100 and the second computing device 902 are in communication by way of a suitable wireless connection. A user places the digit 108 on the touch-sensitive display 102 of the computing device 100 and leaves such digit 108 stationary for some threshold amount of time, thereby initiating virtual joystick functionality. This can cause graphical data (e.g. a cursor 906) to be displayed on the display screen 904 of the second computing device 902 (e.g. a television). While the digit 108 remains relatively stationary on the touch-sensitive display 102, the digit 108 is leaned in a desired direction of movement of the cursor 906. Position/movement of the cursor 906 on the display screen 904 of the second computing device 902 echoes the direction and amount of lean of the digit 108 as detected on the touch-sensitive display 102 of the computing device 100. The virtual joystick functionality can be disabled when the digit 108 is removed from the touch-sensitive display 102 or when the digit 108 changes position relatively rapidly on the touch-sensitive display 102 (e.g., a swipe is performed by the digit 108).

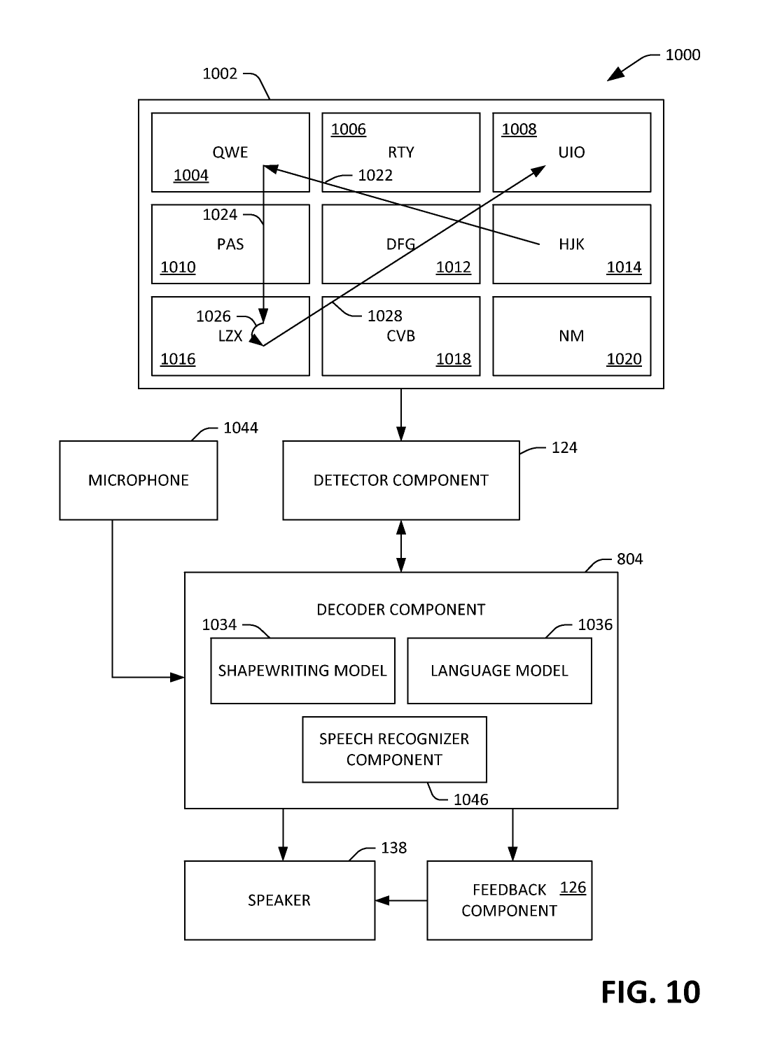

Referring now to FIG. 10, an exemplary system 1000 that facilitates decoding text input by way of shape writing is illustrated. Pursuant to an example, the computing device 100 can comprise the system 1000. Accordingly, a SIP 1002 can be displayed on the touch-sensitive display 102 of the computing device 100. The SIP 1002 comprises a plurality of keys 1004-1020. In the embodiment shown in FIG. 10, each of the keys 1004-1020 is a respective character key, in that each key is representative of a respective plurality of characters. The SIP 1002 may also include additional keys, such as an “enter” key, a space bar key, numerical keys, and other keys found on conventional keyboards.

As shown, each of the keys 1004-1020 in the SIP 1002 is representative of a respective plurality of characters. For example, the key 1004 is representative of the characters “Q,” “W,” and “E,” the key 1006 is representative of the characters are “R,” “T,” and “Y,” etc. In other embodiments, characters can be arranged in alphabetical order or in some other suitable arrangement.

In an exemplary embodiment, the SIP 1002 is configured to receive input from the digit 108 of a user by way of shape writing (e.g., a continuous sequence of strokes over the SIP 1002). A stroke, as the term is used herein, is the transition of the digit 108 (e.g. a thumb) of the user from a first key in the plurality of keys 1004-1020 to a second key in the plurality of keys 1004-1020, while the digit 108 maintains contact with the SIP 1002. A continuous sequence of strokes then, is a sequence of such strokes where the digit 108 of the user maintains contact with the SIP 1002 throughout the sequence of strokes. In other words, rather than the user tapping discrete keys on the SIP 1002, the user can employ her digit (or a stylus or pen) to connect keys that are representative of respective letters in a desired word. A sequence of strokes 1022-1028 illustrates employment of shape writing to set forth the word “hello.” While the sequence of strokes 1022-1028 is shown as being discrete strokes, it is to be understood that, in practice, a trace of the digit 108 of the user over the SIP 1002 may be a continuous curved shape with no readily ascertainable differentiation between strokes.

The system 1000 comprises the detector component 124 that can detect strokes set forth by the user over the SIP 1002. Therefore, for example, the detector component 124 can detect the sequence of strokes 1022-1028, wherein the user transitions her digit 108 from the key 1014 to the key 1004, followed by transition of her digit to the key 1016, followed by her transition of her digit to the key 1008.

In the exemplary embodiment shown in FIG. 10, the decoder component 804 is in communication with the detector component 124 and decodes the sequence of strokes 1022-1028 set forth by the user of the SIP 1002, such that the decoder component 804 determines a sequence of characters (e.g., a word) desirably set forth by such user. Pursuant to an example, the decoder component 804 can receive a signal from the detector component 124 that is indicative of the sequence of strokes 1022-1028 set forth by the user over the SIP 1002, can decode such sequence of strokes 1022-1028, and can output the word “hello.” As each of the keys 1004-1020 is representative of a respective plurality of characters, the decoder component 804 can disambiguate between potential words that can be constructed based upon the strokes set forth by the user (e.g., based upon characters in respective keys over which a trace of the digit 108 has passed or to which the trace of the digit 108 is proximate). Still further, the decoder component 804 can be configured to correct for possible spelling errors entered by the user, as well as errors in position of the digit 108 over the keys 1004-1020 in the SIP 1002. As noted above, the SIP 1002 may be particularly well-suited for eyes-free entry of text by the user of the SIP 1002. Therefore, when the user is interacting with the SIP 1002, her digit 108 may not be positioned precisely over respective keys that are desirably selected by the user.

In connection with performing such decoding, the decoder component 804 can comprise a shape writing model 1034 that is trained using labeled words and corresponding traces over the SIP 1002 set forth by users. With more particularity, during a data collection/model training phase, a user can be instructed to set forth a trace (e.g., continuous sequence of strokes) over a soft input panel for a prescribed word. Position of such trace can be assigned to the word and such operation can be repeated for multiple different users and multiple different words. As can be recognized, variances can be learned and applied to traces for certain words, such that the resultant shape writing model 1034 can relatively accurately model sequences of strokes for a variety of different words in a predefined dictionary. Moreover, if the operation is repeated for a sufficient number of many differing words, the shape writing model 1034 can generalize to new words, relatively accurately modeling sequences of strokes for words that are not in the predefined dictionary but have similar patterns of characters.

Furthermore, the decoder component 804 can optionally include a language model 1036 for a particular language, such as, English, Japanese, German, or the like. The language model 1036 can be employed to probabilistically disambiguate between potential words based upon previous words set forth by the user.

The system 1000 may further optionally include the speaker 138 that can audibly output a word or sequence of words decoded by the decoder component 804 based upon sequences of strokes detected by the detector component 124. In an exemplary embodiment, the speaker 138 can audibly output the word “hello” in response to the user performing the sequence of strokes 1022-1028 over the SIP 1002. Accordingly, the user need not look at the SIP 1002 to receive confirmation that the word desirably entered by the user has been accurately decoded. Alternatively, if the decoder component 804 incorrectly decodes a word based upon the sequence of strokes 1022-1028 detected by the detector component 124, the user can receive audible feedback that informs the user of the incorrect decoding of the word. For instance, if the decoder component 804 decodes the word desirably set forth by the user as being “orange,” then the user can quickly ascertain that the decoder component 804 has incorrectly decoded the word desirably set forth by the user. The user may then press some button (not shown) that causes the decoder component 804 to output a next most probable word, which can be audibly output by the speaker 138. Such process can continue until the user hears the word desirably entered by such user. In other embodiments, the user, by way of a gesture or voice command, can indicate a desire to re-perform the sequence of strokes 1022-1028, such that the previously decoded word is deleted. In still another example, the decoder component 804 can decode a word prior to the sequence of strokes being completed, and can cause such word to be displayed prior to the sequence of strokes being completed. For instance, as the user sets forth a sequence of strokes, a plurality of potential words can be displayed to the user.

Furthermore, it can be recognized that the decoder component 804 can employ active learning to update the shape writing model 1034 and/or the language model 1036 based upon feedback set forth by the user of the SIP 1002 when setting forth sequences of strokes. That is, the shape writing model 1034 can be refined based upon size of the digit 108 of the user used to set forth traces over the SIP 1002, shapes of traces set forth by the user over the SIP 1002, etc. Similarly, the dictionary utilized by the shape writing model 1034 and/or the language model 1036 can be updated based upon words frequently employed by the user of the SIP 1002 or an application being executed by the computing device 100. For example, if the user desires to set forth a name of a person that is not included in the dictionary of the shape writing model 1034, the user can inform the decoder component 804 of the name, such that subsequent sequences of strokes corresponding to such name can be recognized and decoded by the decoder component 804. In another example, a dictionary can be customized based upon an application for which text is being generated. For instance, words/sequences of characters set forth by the user when employing a text messaging application may be different from words/sequences of characters set forth by the user when employing an e-mail or word processing application.

The system 1000 may optionally include a microphone 1044 that can receive voice input from the user. The user, as noted above, can set forth a voice indication that the decoder component 804 has improperly decoded a sequence of strokes and the microphone 1044 can receive such voice indication. In another exemplary embodiment, the decoder component 804 can optionally include a speech recognizer component 1046 that is configured to receive spoken utterances of the user and recognize words therein. In an exemplary embodiment, the user can verbally output words that are also entered by way of a trace over the SIP 1002, such that spoken words supplement the sequence of strokes and vice versa. Thus, for example, the shape writing model 1034 can receive an indication of a most probable word output by the speech recognizer component 1046 (where the spoken word was initially received from the microphone 1044), and can utilize such output to further assist in decoding a trace set forth over the SIP 1002. In another embodiment, the speech recognizer component 1046 can receive a most probable word output by the shape writing model 1034 based upon a trace detected by the detector component 124, and can utilize such output as a feature for decoding the spoken word. The utilization of the speech recognizer component 1046, the shape writing model 1034, and the language model 1036 can enhance accuracy of decoding.

The system 1000 can further include the feedback component 126, which is configured to cause the speaker 138 to output audible feedback corresponding to a sequence of strokes undertaken by a user relative to the SIP 1002, wherein the audible feedback can be perceived by the user as being an audible signature for such sequence of strokes. In other words, the feedback component 126 can be configured to cause the speaker 138 to output distinct auditory signals for shape-written strokes, such that auditory feedback is provided to the user when such user has set forth a sequence of strokes correctly. This is analogous to a trail of touch points, which provides visual feedback to a user to assist the user in selecting/tracing over desired keys. The feedback component 126 can cause the speaker 138 to output real-time auditory effects, depending on properties of strokes in the sequence of strokes. Such auditory effects include, but are not limited to, pitch, amplitude, particular sounds (e.g., race car sounds, jet sounds, . . . ) and the like. These auditory effects can depend upon various properties of a stroke or sequence of strokes detected by the detector component 124. Such properties can include, for instance, a velocity of a stroke, an acceleration of a stroke, a rotational angle of a touch point with respect to an anchor point (e.g., the start of a stroke, sharp turns, etc.), angular velocity of a stroke, angular acceleration of a stroke, etc. Accordingly, through repeated use of the SIP 1002, the user can consistently set forth sequences of strokes for commonly used words and can learn an auditory signal that corresponds to such sequence of strokes.

The auditory effects output by the speaker 138 can include tones or other types of auditory effects that mimic moving objects, such as the sound of a moving train, a racecar, a swipe of a sword, a jet, a speeding bullet, amongst other auditory effects. In another exemplary embodiment, the feedback component 126 can 339104.01 also cause visual effects to be provided as the user interacts with the SIP 1002. Such visual effects can include, for instance, effects corresponding to auditory feedback output by the speaker 138, such as a visualization of a speeding bullet, jet exhaust, tread tracks for a racecar, etc. Thus, a trail following the sequence of strokes can provide the user with visual and entertaining feedback pertaining to sequences of strokes.

While the SIP 1002 has been shown and described as being a condensed input panel, where each key represents a respective plurality of characters, it is to be understood that the auditory feedback can be provided when the SIP 1002 does not include multi-character keys. For instance, the SIP 1002 may be a conventional SIP, where each key represents a single character.

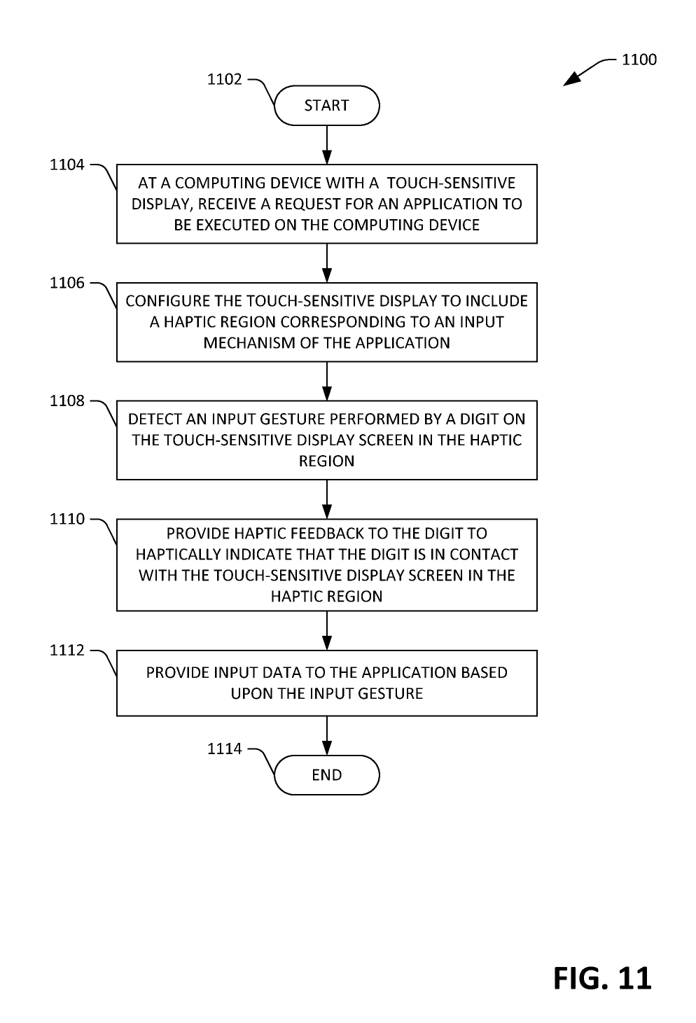

FIGS. 11-13 illustrate exemplary methodologies relating to computing devices with touch-sensitive displays. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Now referring to FIG. 11, an exemplary methodology 1100 that facilitates provision of haptic feedback to a user employing a smooth touch-sensitive display surface of a computing device is illustrated. The methodology 1100 starts at 1102, and at 1104, at a computing device with a touch-sensitive display screen, a request to initiate execution of an (arbitrary) application on the computing device is received. The application, when executed by the computing device, can cause the computing device to act as a particular type of computing device, such as an input or control device for some other device. Exemplary types of computing device can include a portable music player, an automobile infotainment system, a video game controller, a remote control for a television or audio/video equipment, a control panel for an industrial machine, etc.

At 1106, responsive to receiving the request at 1104, the touch-sensitive display is configured to comprise a haptic region that corresponds to an input mechanism for the particular type of computing device corresponding to the requested application. Hence, such haptic region can correspond to a button, a switch, a slider, a track pad, etc. At 1108, an input gesture performed by a digit on the touch-sensitive display screen is detected in the haptic region. Thus, for instance, a digit can transition over a boundary of the haptic region, can tap on the display screen at the haptic region, etc.

At 1110, responsive to detecting the input gesture, haptic feedback is provided to the digit to haptically indicate that the digit is in contact with the touch-sensitive display screen in the haptic region. Such haptic feedback may be electrostatic friction, vibration caused by some other suitable actuator, etc. At 1112, input data is provided to the application based upon the input gesture detected at 1108. The application may then generate output data based upon the input gesture which, for instance, can be used to control at least one operation of a second computing device. The methodology 1100 completes at 1114.

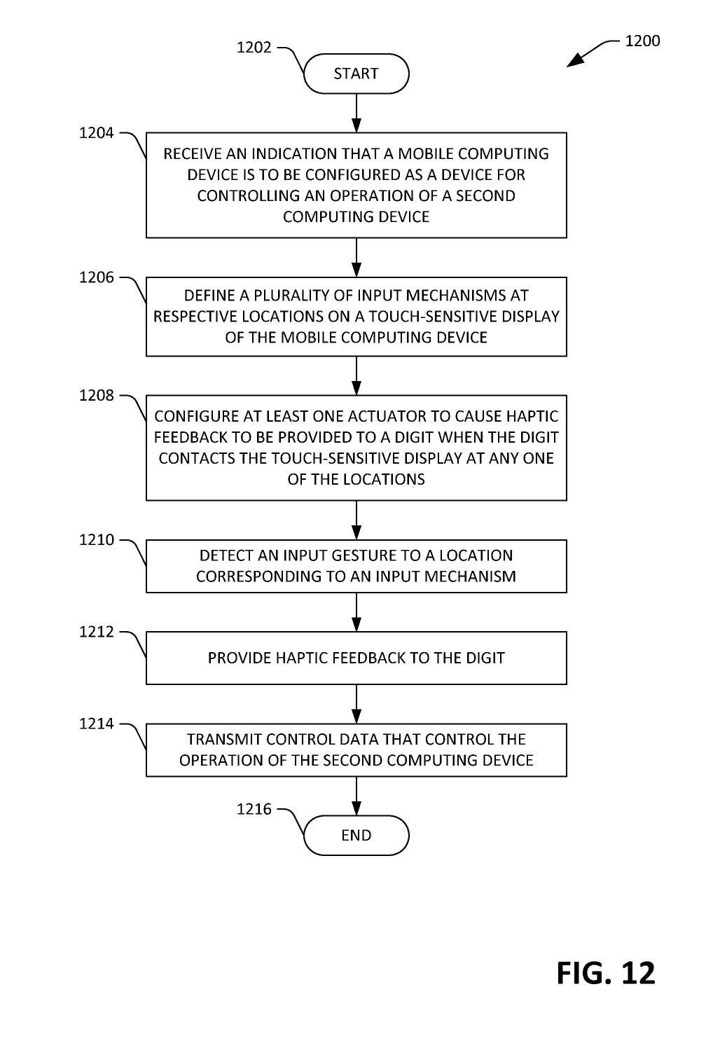

With reference now to FIG. 12, an exemplary methodology 1200 that facilitates utilizing a computing device to control an operation of a second computing device is illustrated. The methodology 1200 starts at 1202, and at 1204, at a mobile computing device comprising a touch-sensitive display, an indication is received that the mobile computing device is to be configured as a device for controlling an operation of a second computing device. For instance, the indication can be received that the mobile computing device is to be configured as a television remote control, set top box remote control, a video game controller, etc.

At 1206, a plurality of input mechanisms at respective locations on the touch-sensitive display are defined, wherein the input mechanisms are representative of physical human-machine interfaces, such as, buttons, sliders, switches, dials, etc.

At 1208, at least one actuator is configured to cause haptic feedback to be provided to a digit when the digit contacts the touch-sensitive display at any of the respective locations of the input mechanisms. Additionally, auditory and/or visual feedback may likewise be provided. At 1210, an input gesture at a location corresponding to an input mechanism on the touch-sensitive displays received. Such input gesture may be a swipe, tap, pinch, rotation, etc. At 1212, haptic feedback is provided to the digit based upon the detecting of the input gesture at the location corresponding to the input mechanism at 1210. At 1214, control data that controls the operation of the second computing device is transmitted based upon detecting of the input gesture at the location corresponding to the input mechanism at 1210. The methodology 1200 completes at 1216.

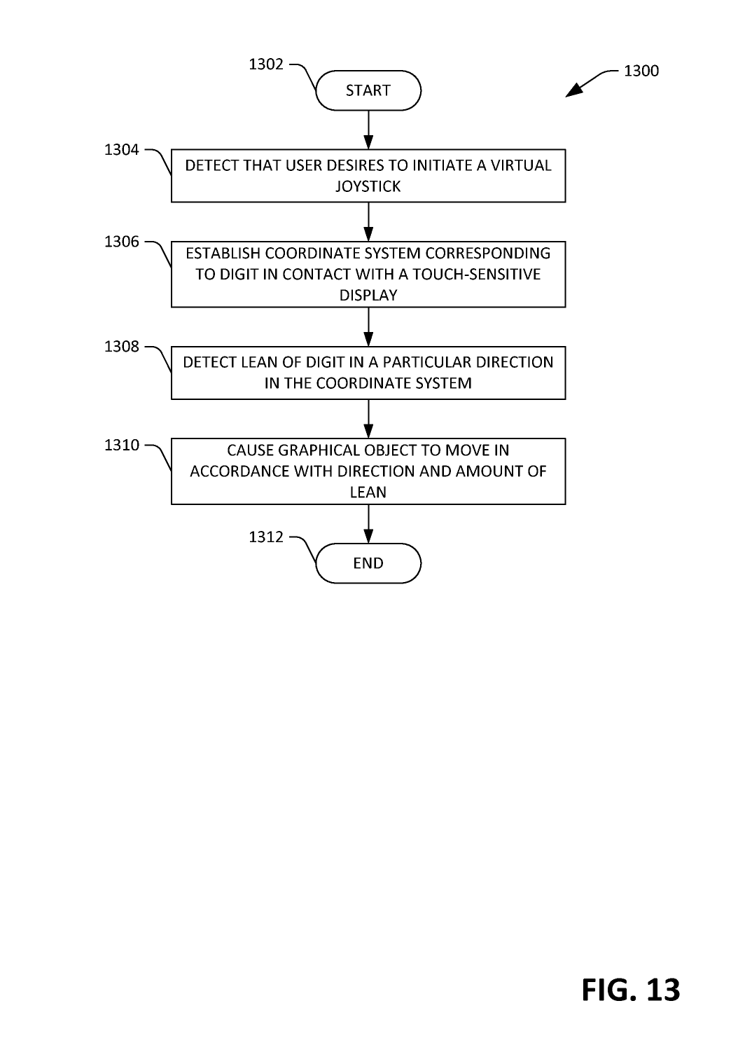

Now referring to FIG. 13, an exemplary methodology 1300 that facilitates use of a virtual joystick (virtual pointing stick) is illustrated. The methodology 1300 starts at 1302, and at 1304 a detection is made that a user desires to initiate a virtual joystick. At 1306, a coordinate system is established corresponding to a digit in contact with the touch-sensitive display. For instance, the user can initially cause a particular digit to be placed on the touch-sensitive display at a certain orientation relative to edges of the display screen. At 1308, lean of the digit in a particular direction in the coordinate system is detected, and at 1310, a graphical object, either on a display screen where the digit is in contact or another display screen, can be cause to be moved in accordance with the direction and amount of lean detected at 1308. The methodology 1300 completes at 1312.

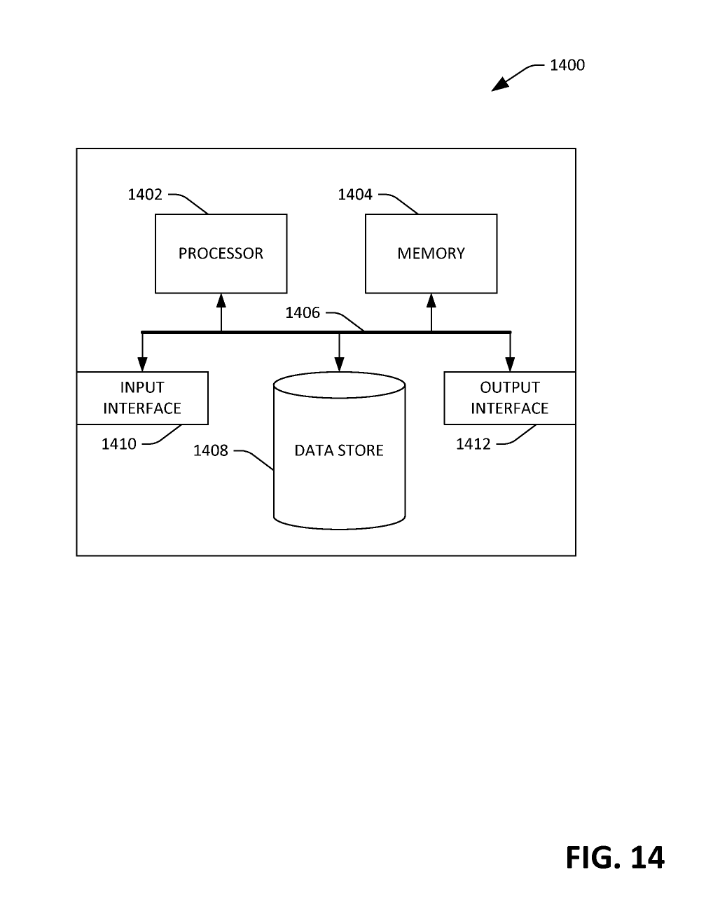

Referring now to FIG. 14, a high-level illustration of an exemplary computing device 1400 that can be used in accordance with the systems and methodologies disclosed herein is illustrated. For instance, the computing device 1400 may be used in a system that supports provision of haptic feedback to a user of a computing device having a touch-sensitive display. By way of another example, the computing device 1400 can be used in a system that supports use of a virtual joystick in connection with a touch-sensitive display. The computing device 1400 includes at least one processor 1402 that executes instructions that are stored in a memory 1404. The instructions may be, for instance, instructions for implementing functionality described as being carried out by one or more components discussed above or instructions for implementing one or more of the methods described above. The processor 1402 may access the memory 1404 by way of a system bus 1406. In addition to storing executable instructions, the memory 1404 may also store locations corresponding to haptic regions, auditory effects that can be output, etc.

The computing device 1400 additionally includes a data store 1408 that is accessible by the processor 1402 by way of the system bus 1406. The data store 1408 may include executable instructions, images, etc. The computing device 1400 also includes an input interface 1410 that allows external devices to communicate with the computing device 1400. For instance, the input interface 1410 may be used to receive instructions from an external computer device, from a user, etc. The computing device 1400 also includes an output interface 1412 that interfaces the computing device 1400 with one or more external devices. For example, the computing device 1400 may display text, images, etc. by way of the output interface 1412.

It is contemplated that the external devices that communicate with the computing device 1400 by way of the input interface 1410 and the output interface 1412 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 1400 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 1400 may be a distributed system. Thus, for instance, several devices may be in communication by way of a network connection and may collectively perform tasks described as being performed by the computing device 1400.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc. Thus, for instance, actions described herein as being performed by a processor may alternatively or additionally be performed by at least one of the hardware logic components referenced above.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A method, comprising:
at a first computing device with a touch-sensitive display screen, receiving a request for an application to be executed on the first computing device, the application, when executed by the first computing device, causes the first computing device to act as a particular type of computing device; and
responsive to receiving the request, configuring the touch-sensitive display to comprise a haptic region that corresponds to an input mechanism for the particular type of computing device.

2. The method of claim 1, the first computing device being a mobile telephone, a slate computing device, or a wearable computing device.

3. The method of claim 1, the particular type of computing device being one of a media player, a television remote control, a video game controller, or an automobile infotainment center.

4. The method of claim 1, further comprising:
detecting an input gesture performed by a digit on the touch-sensitive display screen in the haptic region; and
responsive to detecting the input gesture, providing haptic feedback to the digit to haptically indicate that the digit is in contact with the touch-sensitive display screen in the haptic region, the haptic feedback comprising electrostatic friction.

5. The method of claim 1, further comprising:
detecting an input gesture performed by a digit on the touch-sensitive display screen in the haptic region; and
responsive to detecting the input gesture, providing haptic feedback to the digit to haptically indicate that the digit is in contact with the touch-sensitive display screen in the haptic region, the haptic feedback comprising at least one of vibration or simulated key clicks.

6. The method of claim 1, further comprising:
detecting an input gesture performed by a digit on the touch-sensitive display screen in the haptic region;
responsive to detecting the input gesture:
providing haptic feedback to the digit to haptically indicate that the digit is in contact with the touch-sensitive display screen in the haptic region; and
providing input data to the application based upon the input gesture, wherein the application generates output data based upon the input gesture;
receiving the output data generated by the application; and
responsive to receiving the output data, transmitting a signal from the first computing device to a second computing device, the signal based upon the output data, the signal comprising second input data for a second application executing on the second computing device.

7. The method of claim 6, the second computing device being one of a video game console, a set top box, or a television.

8. The method of claim 1, the input mechanism being one of a button, a click wheel, a slider, a track pad, a keypad, or a keyboard.

9. The method of claim 1, further comprising:
detecting that the first computing device is in communication with a second computing device, wherein the application is configured to cause the first computing device to control an operation of the second computing device, the request based upon detecting that the first computing device is in communication with the second computing device.

10. A computing device, comprising:
a touch-sensitive display;
a processor; and
a memory that comprises a plurality of applications that are executed by the processor, the plurality of applications corresponding to respective configurations of the computing device, the configurations having different respective haptic regions corresponding thereto on the touch-sensitive display, a haptic region of a configuration of an application representing an input mechanism for the configuration and providing haptic feedback when a digit is in contact with the haptic region on the touch-sensitive display, the memory further comprising a plurality of components, the components comprising:
a receiver component that receives an indication that an arbitrary application in the plurality of applications is to be executed by the processor; and
a configurer component that configures the computing device in accordance with the arbitrary application.

11. The computing device of claim 10, wherein the receiver component causes different applications in the plurality of applications to be invoked by respective different invocation input, invocation inputs that invoke respective applications comprising at least one of an orientation of the computing device, an orientation of the computing device relative to a second computing device, a gesture set forth over the touch-sensitive display, or manipulation of hardware of the computing device.

12. The computing device of claim 10, the components further comprising:
a detector component that detects an input gesture over the haptic region; and
a feedback component that, responsive to the detector component detecting the input gesture over the haptic region, causes the touch-sensitive display to provide haptic feedback to the digit performing the input gesture.

13. The computing device of claim 12, the components further comprising:
an input component that generates input data based upon the detector component detecting the input gesture over the haptic region, the input component providing the input data to the arbitrary application, the arbitrary application generating output data based upon the input data; and
a transmitter component that transmits the output data to a second computing device, the output data configured to control an operation of the second computing device.

14. The computing device of claim 13, wherein the second computing device is one of a television, a set top box, a streaming media player, a disk media player, or a game console, and the operation of the second computing device comprises displaying graphical content based upon the output data.

15. The computing device of claim 10, wherein the arbitrary application, when executed by the computing device, causes a virtual joystick to be enabled on the touch-sensitive display, the components further comprising:
a detector component that detects that a digit is in contact with a location on the touch-sensitive display corresponding to the virtual joystick, and further detects that the digit is being leaned in a particular direction; and
a display component that updates graphical data displayed on the touch-sensitive display based upon the detector component detecting that the digit is being leaned in the particular direction.

16. The computing device of claim 10, wherein the arbitrary application, when executed by the computing device, causes a virtual joystick to be enabled on the touch-sensitive display, the components further comprising:
a detector component that detects that a digit is in contact with a location on the touch-sensitive display corresponding to the virtual joystick, and further detects that the digit is being leaned in a particular direction, the arbitrary application generating output data based upon the detector component detecting that the digit is being leaned in the particular direction; and
a transmitter component that transmits the output data to a second computing device, the output data configured to cause the second computing device to update graphical data displayed on a second display based upon the output data.

17. The computing device of claim 10, the arbitrary application causing a soft input panel with a plurality of keys to be presented when the arbitrary application is executed by the processor, and the configurer component configuring the computing device to provide haptic feedback as a digit transitions over keys in the soft input panel.

18. The computing device of claim 17, the components further comprising:
a detector component that detects a sequence of strokes over the soft input panel, the sequence of strokes performed over keys in the plurality of keys that represent characters forming a word; and
an auditory feedback component that outputs an auditory signature for the sequence of strokes.

19. The computing device of claim 18, the feedback component outputting the auditory signature based upon at least one of velocity of a stroke in the sequence of strokes, acceleration of the stroke in the sequence of strokes, rotational angle between strokes in the sequence of strokes, angular acceleration of the stroke in the sequence of strokes, angular velocity of the stroke in the sequence of strokes, or direction of the stroke in the sequence of strokes.

20. A mobile computing device comprising:
a touch-sensitive display; and
a computer-readable storage medium comprising instructions that, when executed by a processor, cause the processor to perform acts comprising:
receiving an indication that the mobile computing device is to be configured as a device for controlling an operation of a second computing device;
responsive to receiving the indication, configuring the mobile computing device as the device for controlling the operation of the second computing device, wherein the configuring comprises:
defining a plurality of input mechanisms at respective locations on the touch-sensitive display, the input mechanisms representative of physical human-machine interfaces; and
configuring at least one actuator to cause haptic feedback to be provided to a digit when the digit contacts the touch-sensitive display at any of the respective locations of the input mechanisms;
detecting an input gesture at a location corresponding to an input mechanism;
providing haptic feedback to the digit based upon detecting of the input gesture at the location corresponding to the input mechanism; and
transmitting control data that controls the operation of the second computing device based upon detecting of the input gesture at the location corresponding to the input mechanism.
